(19) United States
(12) Patent Application Publication
(10) Pub. No.: US 2023/0283366 A1
(43) Pub. Date: Sep. 7, 2023

(54) ENVIRONMENT INFORMATION ACQUISITION SYSTEM, ENVIRONMENT INFORMATION ACQUISITION METHOD, AND RECORDING MEDIUM

(71) Applicant: NEC Corporation, Minato-ku, Tokyo (JP)

(72) Inventor: Yutaka YANO, Tokyo (JP)

(73) Assignee: NEC Corporation, Minato-ku, Tokyo (JP)

(21) Appl. No.: 18/021,994

(22) PCT Filed: Jul. 16, 2021
(86) PCT No.: PCT/JP2021/026835

§ 371 Date: Feb. 17, 2023

(30) Foreign Application Priority Data
Aug. 27, 2020 (JP) 2020-143155

(51) Int. Cl. H04B 10/071; G01D 5/353

(52) U.S. Cl. CPC H04B 10/071; G01D 5/35358

(57) ABSTRACT

To facilitate the acquisition of environment information for a distant observation point, this environment information acquisition system is made to comprise a Fiber Bragg Grating (FBG) sensor that is placed on an optical path comprising optical fiber and has a grating pitch that changes according to surrounding environment information, a detection unit for detecting the phase variation of probe light that is transmitted via the optical fiber and reflected by the FBG sensor as return light, and an environment information calculation unit for calculating surrounding environment information for the FBG sensor from the phase variation.

### TECHNICAL FIELD

The present disclosure relates to an environment information acquisition device, an environment information acquisition system, an environment information acquisition method, and an environment information acquisition program that use an FBG.

### BACKGROUND ART

### Reading by FBG Sensor

A fiber Bragg grating (FBG) is an optical fiber-type element achieved by writing a periodical refractive index change in a longitudinal direction of a core of an optical fiber and forming a diffractive grating. In the FBG, only light of a wavelength fitted in a period of a diffractive grating is reflected and is generated as return light. When the FBG is expanded and contracted by applying the FBG with force, etc., a period of the diffractive grating is changed and a wavelength of reflection return light is thus changed. Therefore, the FBG serves as a sensor (FBG sensor) for environment information such as distortion, temperature, and pressure. In general, reading by the FBG sensor is performed by causing white light to enter the FBG and acquiring a wavelength change from incident light in reflection light. A device that performs reading by the FBG sensor is generally referred to also as an interrogator.

Only environment information in one location can be sensed by one FBG. In order to perform sensing for a plurality of points, generally, a plurality of FBGs are connected to one optical fiber and reflection light from the plurality of FBGs is acquired by one interrogator. This configuration is one embodiment of a sensing network based on an optical fiber and does not require electric wiring, and therefore has characteristics that an insulation failure or the like is unlikely to occur, an influence of electromagnetic noise is not exhibited, and the like. Such an FBG sensor technique is explained, for example, in section 2-1-21, section 2-1-22, and section 3-2-4 of NPL 1.

### Multipoint Sensing

When many FBGs are connected to one optical fiber in a row (hereinafter, referred to as multipoint FBG sensing), an interrogator needs to discriminate from which FBG return light comes. As the discrimination method, two methods, i.e., a time-division multiplexing method and a wavelength-division multiplexing method are known (see section 4-2-4 and the like of NPL 1),

In the wavelength-division multiplexing method, a plurality of types of FBGs different in reflection wavelength are prepared and each FBG is discriminated according to a difference in reflection wavelength. An increase of the number of reflection wavelengths is limited from a point of view of management. Therefore, the wavelength-division multiplexing method is suitable for an application in which a density of measurement points is not excessively high.

In the time-division multiplexing method, similarly to an optical time-domain reflectometry (OTDR) method, each FBG is discriminated based on a time from transmission of light to the FBG to arrival of reflection return light of the light. In the method, reflection wavelengths of FBGs may be the same, and therefore an upper limit of the number of measurement points is relaxed. However, in the method, it is difficult to read a wavelength change of each FBG. In the time-division multiplexing method, generally, pulsed white light or sweep light is transmitted and a matter that light of what wavelength is reflected is acquired by detecting intensity of return light, and thereby a reflection wavelength change of each FBG is read.

### Optical Fiber Sensing Technique

In optical fiber sensing, for example, coherent light is caused to enter a sensing optical fiber and return light from portions of the sensing optical fiber is detected and analyzed, and thereby disturbance (dynamic distortion) acting on the sensing optical fiber is acquired as environment information. When light is passed through an optical fiber, reflection return light based on a scattering phenomenon including Rayleigh scattering is always generated. Optical fiber sensing acquires environment information from the reflection return light. A measurement instrument that acquires environment information from reflection return light in optical fiber sensing is also referred to as an interrogator.

Disturbance acting on reflection return light is typically an acoustic elastic wave propagating through a sensing optical fiber. The sensing technique is referred to as distributed acoustic sensing (DAS). In DAS, an optical fiber serves as a sensor, differently from sensing using an FBG. Therefore, sensors in DAS are linearly distributed along the optical fiber. This is the reason for being referred to as “a distributed type”. Techniques for DAS are disclosed, for example, in PTLs 1 and 2 and NPL 2.

DAS is also classified as a sensing method based on an OTDR method. Typical OTDR measures intensity of light reflected and returned in a distributed manner, based on Rayleigh scattering of pulsed light transmitted to an optical fiber. OTDR using coherent detection is commercialized and similarly measures intensity of reflection return light.

In the OTDR method, a location of each reflection point on an optical fiber is recognized based on a time difference from emission of an optical pulse to arrival of return light of the optical pulse. When there is an excessive loss or an abnormal reflection point in a middle of an optical fiber line, a change of intensity of return light other than a change based on a transmission loss appears. Therefore, OTDR is being used for applications for checking soundness of an optical fiber line and for specifying an abnormal point.

DAS can be regarded as one type of the OTDR method, but there is a difference that a phase change of light returning with distributed reflection from an optical fiber is measured.

While exhibiting high sensitivity in detection performance for environment information, DAS is characterized by wide distribution sensing without limitation to points, and therefore, is not capable of strengthening reflection return light and has difficulty in acquiring environment information in a specific observation point of a distant location.

In contrast, in the FBG, a sensing point is limited more than in DAS and a density of measurement points is decreased, but more reflection return light can be acquired per one measurement point.

A sensing system using a common FBG detects intensity of reflection light from the FBG and measures a change in wavelength of the reflection light. Therefore, in the sensing system using a common FBG, intensity of reflection light is larger than in DAS, but detection performance for a wavelength change is small.

### CITATION LIST

### Patent Literature

PTL 1] GB Patent No. 2126820 specification
PTL 2] Japanese Unexamined Patent Application Publication No. S59-148835
PTL 3] Japanese Patent No. 3307334

### Non Patent Literature

NPL 1] Introduction to Optical Fiber Sensors, Editorial supervisors Kazuo Hotate and Hideaki Murayama, Photonic Sensing Consortium, published by Optronics Co., Ltd, in April 2012
NPL 2] R. Posey Jr, G. A. Johnson and S.T. Vohra, “Strain sensing based on coherent Rayleigh scattering in an optical fibre”, ELECTRONICS LETTERS, 28th September 2000, Vol. 36 No. 20, pp.1688 to 1689

### SUMMARY OF INVENTION

### Technical Problem

In the sensing system using a common FBG, which is explained in the section of Background Art, a wavelength change of reflection light from the FBG is measured by analyzing intensity of the reflection light. Therefore, the sensing system using a common FBG is not capable of sufficiently acquiring output representing a wavelength change for easily acquiring environment information in a distant observation point.

An object of the present invention is to provide an environment information acquisition system and the like that easily acquire environment information in a distant observation point.

### Solution to Problem

An environment information acquisition system according to the present invention includes: a fiber Bragg grating (FBG) sensor being a sensor including an FBG in which a grating pitch changes according to peripheral environment information, the FBG sensor being installed on an optical path including an optical fiber; a detection unit that detects a phase change of reflection return light from the FBG sensor with respect to probe light transmitted via the optical fiber; and an environment information calculation unit that calculates, based on the phase change, environment information in a periphery of the FBG sensor.

### Advantageous Effects of Invention

The environment information acquisition system and the like according to the present invention easily acquire environment information in a distant observation point.

### BRIEF DESCRIPTION OF DRAWINGS

FIG. 1 is a conceptual diagram illustrating a configuration of a sensing system according to a first example embodiment.

FIG. 2 is a conceptual diagram illustrating one example of a configuration of an environment information acquisition device.

FIG. 3 is a conceptual diagram illustrating one example of a configuration of a partial reflector.

FIG. 4 is an explanatory diagram (No. 1) of an advantageous effect based on adjustment of a reflectance of the partial reflector.

FIG. 5 is an explanatory diagram (No. 2) of an advantageous effect based on adjustment of a reflectance of the partial reflector.

FIG. 6 is a schematic diagram illustrating a configuration of a sensing system according to a second example embodiment.

FIG. 7 is a conceptual diagram illustrating one example of the configuration of the sensing system according to the second example embodiment.

FIG. 8 is a conceptual diagram illustrating a path for transferring reflection return light to an opposite optical fiber core wire.

FIG. 9 is a schematic diagram illustrating one example of a configuration in which an FBG sensor is placed outside a housing of an amplification repeater device and senses peripheral environment.

FIG. 10 is a conceptual diagram illustrating one example of a configuration in which an FBG sensor is placed outside a housing of an amplification repeater device and senses peripheral environment.

FIG. 11 is a conceptual diagram illustrating one example of the configuration in which an FBG sensor is placed outside a housing of an amplification repeater device and senses peripheral environment.

FIG. 12 is a conceptual diagram illustrating a minimum configuration of an environment information acquisition device according to the example embodiments.

### EXAMPLE EMBODIMENT

Hereinafter, with reference to the drawings, example embodiments according to the present invention are explained. In order to clarify explanation, the following description and drawings are omitted and simplified, as appropriate. In the following drawings, the same element is assigned with the same reference sign, and overlapping explanation is omitted, as necessary.

### First Example Embodiment

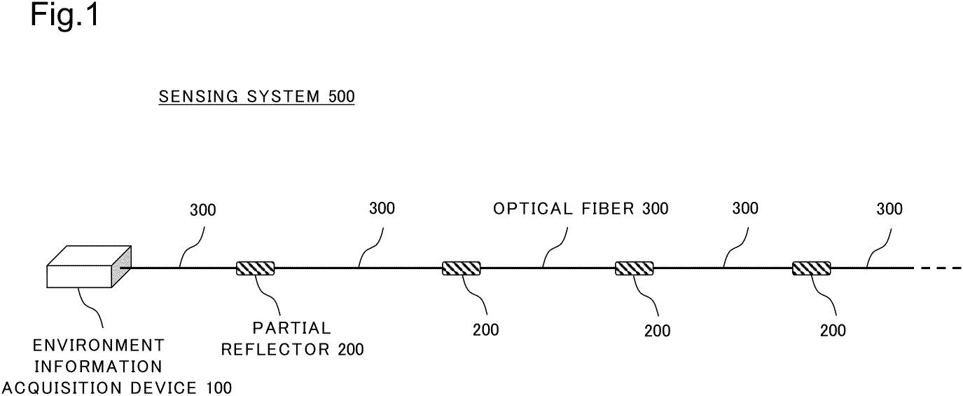

With reference to FIG. 1, a configuration of a sensing system 500 being an example of a sensing system according to a first example embodiment is explained. The sensing system 500 in FIG. 1 includes an environment information acquisition device 100, a plurality of partial reflectors 200, and an optical fiber 300 connecting the environment information acquisition device 100 and the plurality of partial reflectors 200.

The environment information acquisition device 100 is configured by including a DAS interrogator. The partial reflector 200 includes an FBG being a sensor and the like for acquiring environment information. A part of probe light being output from the environment information acquisition device 100 is reflected in each of the partial reflectors 200. Reflection light reflected in each of the partial reflectors 200 includes environment information in a periphery of the partial reflector 200. The environment information is, for example, intensity of an acoustic vibration wave, temperature, or pressure. The reflection light is return light traveling oppositely to the probe light and travels to the environment information acquisition device 100.

### [Configuration Example of Environment Information Acquisition Device 100]

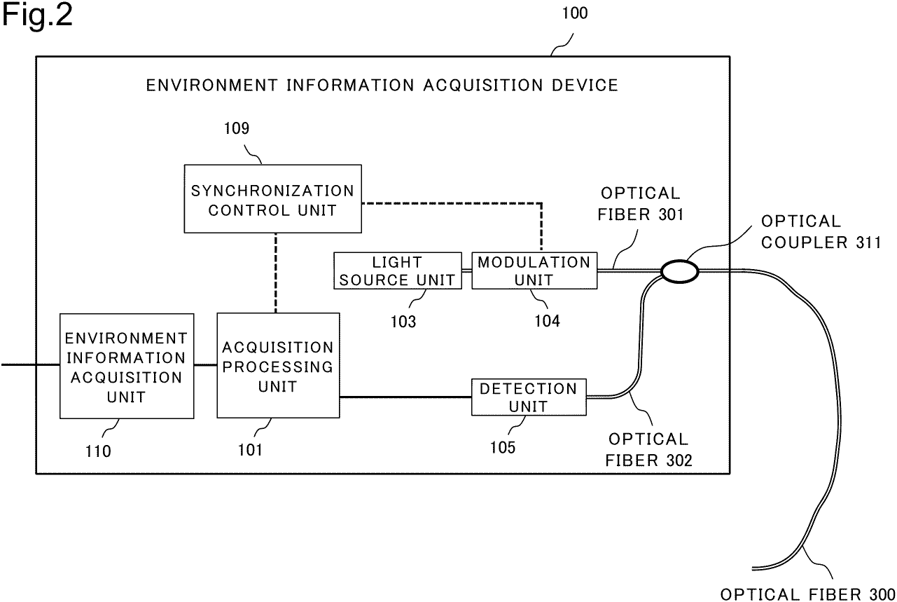

FIG. 2 is a conceptual diagram illustrating a configuration example of the environment information acquisition device 100 in FIG. 1. The environment information acquisition device 100 includes an acquisition processing unit 101, a synchronization control unit 109, a light source unit 103, a modulation unit 104, a detection unit 105, and an environment information acquisition unit 110. The modulation unit 104 is connected to the optical fiber 300 via an optical fiber 301 and an optical coupler 311, and the detection unit 105 is connected to the optical fiber 300 via the optical coupler 311 and an optical fiber 302.

The light source unit 103 includes a laser light source and causes a continuous laser beam to enter the modulation unit 104.

The modulation unit 104 is synchronized with a trigger signal from the synchronization control unit 109, for example, amplitude-modulates a continuous laser beam incident from the light source unit 103, and generates probe light of a sensing signal wavelength. The probe light is, for example, pulse-shaped. The modulation unit 104 transmits the probe light to the optical fiber 300 via the optical fiber 301 and the optical coupler 311.

The synchronization control unit 109 also transmits the trigger signal to the acquisition processing unit 101 and reports what piece of data being input via continuous analog/digital (A/D) conversion indicates a time original point.

When the transmission is performed, return light from locations of the optical fiber 300 and each of the partial reflectors 200 reaches, via the optical fiber 302, the detection unit 105 from the optical coupler 311. As described above, a reflectance of the partial reflector 200 is higher than a reflectance of a scattering phenomenon of the optical fiber 300 itself, and therefore intensity of return light from the partial reflector 200 is markedly larger than the intensity of return light based on the scattering phenomenon of the optical fiber 300 itself. Return light from each location of the optical fiber 300 and the partial reflector 200 reaches the environment information acquisition device 100 in a shorter time from transmission of probe light, as the return light is reflected from a location closer to the environment information acquisition device 100. When a certain location of the optical fiber 300 or the partial reflector 200 is affected by an environment such as presence of a sound, in reflection light generated in the location, a phase change from probe light occurs due to the environment.

Return light in which the phase change occurs is detected by the detection unit 105. While a method for the detection includes well-known synchronization detection and delay detection, any either of the methods is usable. A configuration for performing phase detection is well-known, and therefore explanation thereof is omitted herein. An electric signal (detection signal) acquired by the detection is an electric signal in which a degree of phase change is represented by amplitude or the like. The electric signal is input to the acquisition processing unit 101.

The acquisition processing unit 101 first A/D-converts the above-described electric signal into digital data. Then, the acquisition processing unit 101 determines, for example, in a form of a difference from the last measurement in the same point, a phase change, from the last measurement, of light scattered and returned in each point of the optical fiber 300 and the partial reflector 200. The signal processing is a common technique for DAS using an optical fiber as a sensor, and therefore detailed explanation thereof is omitted.

The acquisition processing unit 101 derives data in a form similar to data acquired by virtually arranging a dot-shaped electric sensor discretely in points of the optical fiber 300 and the partial reflectors 200. The data are virtual sensor-array output data acquired as a result of signal processing, and thereafter, the data are referred to as RAW data.

The environment information acquisition unit 110 acquires, from RAW data, environment information with respect to data from the partial reflector 200 in which intensity is markedly higher than in a peripheral location and stores the acquired data. The environment information is, for example, an acoustic elastic wave, pressure, or temperature. A specific method of acquiring environment information from RAW data is a common technique for DAS using an optical fiber as a sensor, and therefore detailed explanation thereof is omitted herein.

The acquisition processing unit 101, the synchronization control unit 109, and the environment information acquisition unit 110 are, for example, a central arithmetic processing device of a computer and in this case, are operated based on software including a program and information. The program and the information are previously held in a memory or the like (a memory or a storage unit), being not illustrated, in each of configurations of the units. The acquisition processing unit 101, the synchronization control unit 109, and the environment information acquisition unit 110 can store predetermined information in each of memories or the like, being not illustrated, in the configurations of the units. The configurations can further read information stored in the memories or the like.

### [Achievement Example of Partial Reflector]

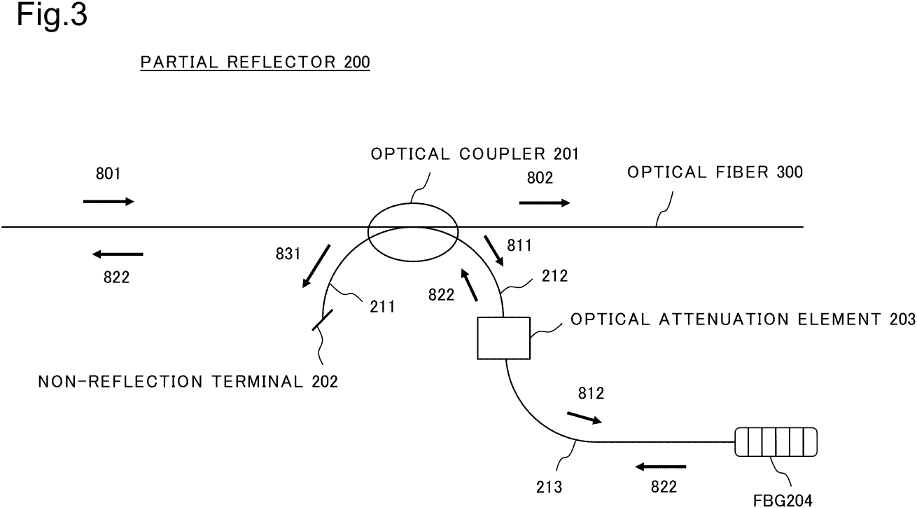

FIG. 3 is a conceptual diagram illustrating a configuration example of the partial reflector 200. The partial reflector 200 includes an optical coupler 201, an optical attenuation element 203, and an FBG 204. The FBG 204 is a sensor (FBG sensor) for acquiring environment information.

Probe light 801 from the environment information acquisition device 100 in FIG. 1 propagates through the optical fiber 300 in a right direction. Herein, a probe light wavelength is matched with a reflection wavelength of the FBG 204. A part of the probe light 801 is branched by the optical coupler 201 to probe light 811, and the branched probe light 811 is propagated through an optical fiber 212. The probe light 811 is attenuated by the optical attenuation element 203, and then propagated, as probe light 812, through an optical fiber 213, and reflected by the FBG 204. Reflection light 822 relevant to the reflection includes environment information of the FBG 204. The reflection light 822 is attenuated by the optical attenuation element 203, caused to enter the optical fiber 300, as reflection light 823, by the optical coupler 201, and propagated, as the reflection light 822, to the environment information acquisition device 100 in FIG. 1.

The optical attenuation element 203 is used for adjusting a reflectance and can be omitted when unnecessary. A non-reflection terminal 202 is a terminal for eliminating reflection at an end of an optical fiber 211, being an unused port of the optical coupler 201, of light 831 transmitted through the optical fiber 211 and can be omitted when there is no unused port.

Herein, in the configuration of FIG. 1, it is assumed that an FBG sensor is not configured as a partial reflector and is directly inserted into the optical fiber 300 being a transmission path. In this case, light reflected by any FBG sensor of FIG. 1 and transmitted through the optical fiber 300 in a right direction is partially reflected again by the next FBG sensor. A part of the reflection light is reflected again by an adjacent FBG on a left side, and as described above, multiple reflection occurs, which is not preferable. As in the partial reflector 200 of FIG. 3, probe light branched via the optical coupler 201 is reflected by the FBG 204, and thereby a problem of the multiple reflection is resolved. The configuration of the partial reflector described herein is a well-known technique as in PTL 3. An achievement means for another partial reflector is usable.

### [Measurement Principle]

Herein, temperature is assumed as environment information of a sensing target. When a temperature changes, an FBG is expanded and contracted based on a thermal expansion phenomenon, and a diffractive grating pitch of the FBG is changed. From the reason, from a phase change of reflection light of probe light with which the FBG is irradiated, a change of temperature can be read. As a material for causing a grating pitch to change based on reflection of a temperature may be silica glass configuring an FBG or may be a material for a base on which an FBG is pasted and held.

Herein, the environment information acquisition device 100 detects a phase change with respect to probe light of reflection return light and reads a temperature change of the FBG. When a change with respect to probe light of reflection light is acquired, generally, a scene where a wavelength of reflection light changes is read by a spectroscope (spectrum analyzer or the like) or a frequency discriminator element (filter). In contrast, in the sensing system according to the present example embodiment, a phase change of reflection light from the FBG is read by the environment information acquisition device 100 being a DAS interrogator.

A diffractive grating of the FBG can be regarded as a multiple reflection resonator. A temperature change of a resonator length of the multiple reflection resonator can be read also as a change of resonance wavelength, but a much finer change can be detected when detection is performed based on a phase change.

However, a phase change is likely to occur very delicately. Therefore, the phase change is likely to occur even due to a factor other than environment information to be measured. The phase change is likely to occur, for example, even due to a sound or a vibration. Therefore, when environment information is acquired based on a phase change of reflection return light, it is necessary to eliminate as many change factors as possible other than environment information to be measured. Information to be measured and information other than the former information may be separated based on frequency after the environment information acquisition device 100 performs light reception/demodulation. For example, an influence of a sound changes in a shorter time than in temperature, and therefore when times are averaged, an influence can be eliminated.

The sensing system according to the present example embodiment is applicable to an FBG sensor that detects various types of environment information. As such an FBG sensor, for example, a temperature sensor, a pressure sensor, and a distortion sensor are supposable.

### [Adjustment of Reflectance of Partial Reflector]

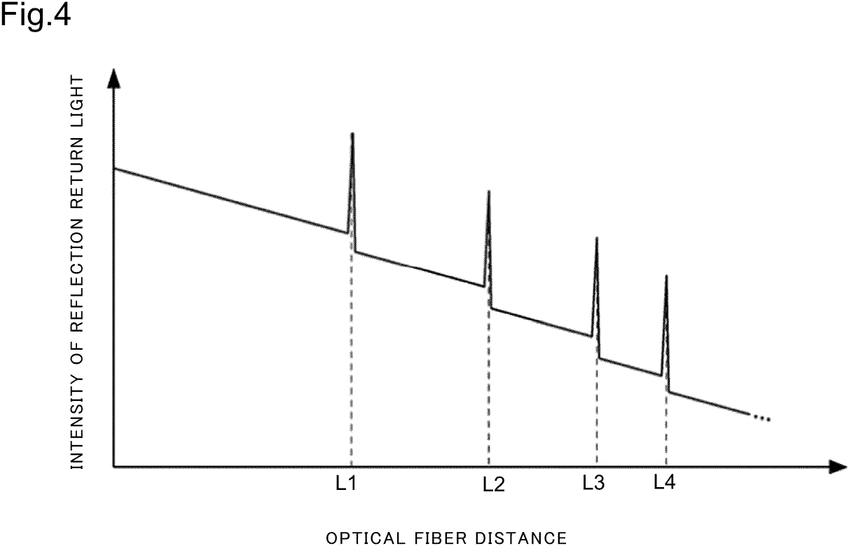

Probe light is attenuated while being transmitted through the optical fiber 300. When the probe light is attenuated and intensity for reaching a partial reflector is decreased, reflection return light is also decreased. Reflection return light in a return path is also attenuated and intensity of the reflection return light received by the environment information acquisition device 100 is decreased. Therefore, when a reflectance of the partial reflector is uniform, optical-fiber distance dependency of intensity of reflection return light appears, for example, as in FIG. 4. Herein, it is assumed that “an optical fiber distance” is a distance along an optical fiber in which the environment information acquisition device 100 is a start point. FIG. 4 is an example in which a partial reflector is installed in each of locations where optical fiber distances are L1 to L4.

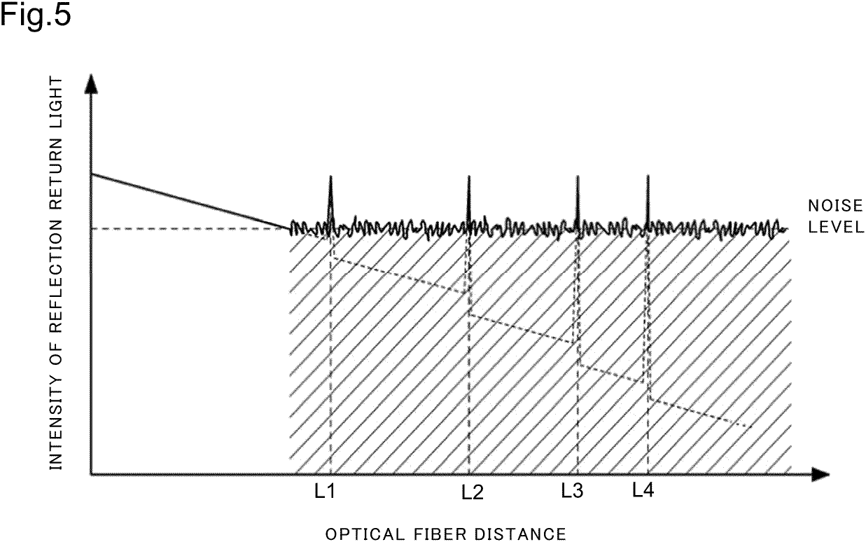

In such a situation, return light from a partial reflector having a long optical fiber distance may be buried in noise. In order to solve the problem, reflectance may be set to be higher as the partial reflector has smaller intensity of probe light reaching the partial reflector. Thereby, for example, as in FIG. 5, even when intensity of probe light reaching the partial reflector is small, the reflection return light is increased, whereby reflection return light can be caused not to be buried in noise and an optical fiber distance enabling acquisition of environment information can be elongated.

### Characteristic Comparison With Configuration in Which Optical Fiber is Used as Sensor

A common DAS sensing system can sense environment information by using an optical fiber being an optical signal medium, without using an FBG sensor particularly. However, in an application in which distributed sensing is not highly required and it is sufficient that only a specific location can be sensed, a configuration using an FBG sensor may be more advantageous than a common DAS system in the following two points. One point is that an FBG can be caused to have a reflectance higher than a common optical fiber, and therefore reflection return light can be received with a high S/N ratio.

Another point is that an FBG can be accommodated in a package specializing in a physical phenomenon intended to be sensed, and therefore sensitivity to the physical phenomenon intended to be sensed can be increased more than in another physical phenomenon. In a case of DAS in which an elongated optical fiber is used as a sensor, there is a disadvantage in that a plurality of physical phenomena such as vibration, temperature, lateral pressure distortion, and tension are observed as a mixture. In contrast, in use of FBG, when, for example, a temperature change is intended to be sensed with high sensitivity, it is effective that the FBG is pasted to a material having a large thermal expansion coefficient and is accommodated in a package being caused to have a strength in which it is difficult for distortion caused by an external force to reach the FBG, or the like is effective. Thereby, an FBG sensor in which sensitivity to a temperature change is exhibited and an adverse influence due to distortion or the like caused by an external force is reduced can be achieved.

### [Advantageous Effect]

The sensing system according to the present example embodiment uses an FBG as a sensor for acquiring environment information and acquires a degree of a grating pitch change of the FBG from a phase change of reflection return light from the FBG. Therefore, the sensing system can increase a reflection light amount from the sensor for acquiring environment information instead of limiting observation points, compared with an optical fiber used for common distributed sensing based on DAS. In addition, the sensing system further detects a phase change of reflection return light from an FBG, acquires a degree of a grating pitch change, and thereby can acquire environment information with higher sensitivity, compared with a method of analyzing intensity of reflection return light from an FBG and acquiring a degree of a grating pitch change. Thereby, the sensing system easily acquires, with higher accuracy, environment information in a distant observation point.

An FBG used as a sensor in the sensing system according to the present example embodiment does not require power supply in order to function as the sensor, similarly to an optical fiber used for common fiber sensing. Therefore, the sensing system according to the present example embodiment does not require a configuration for supplying power to a sensor unit that acquires environment information.

### Second Example Embodiment

In a sensing system according to the present example embodiment, an optical amplification repeater that repeater-amplifies probe light and reflection light of the probe light is inserted into the optical fiber 300 of the sensing system 500 according to the first example embodiment, and thereby environment information in a location of a further-elongated optical fiber distance can be acquired.

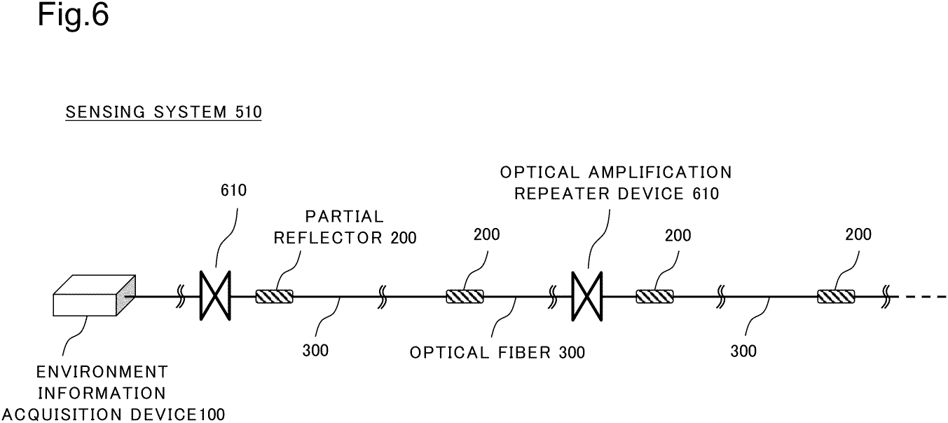

FIG. 6 is a conceptual diagram illustrating a sensing system 510 being an example of the sensing system according to the present example embodiment. In the sensing system 510 of FIG. 6, a partial reflector 200 is disposed in a plurality of measurement points, similarly to the partial reflector 200 in FIG. 1. In addition, in the sensing system 510 of FIG. 6, a plurality of optical amplification repeater devices 610 that each compensate attenuation of light are inserted. Therefore, sensing up to a farther distance can be performed than according to the first example embodiment.

The sensing systems 500 and 510 may be integrated with an optical fiber transmission system for transmitting a communication optical signal. When integrated, probe light to be used for sensing and communication light to be used for communication are disposed for wavelengths different from each other.

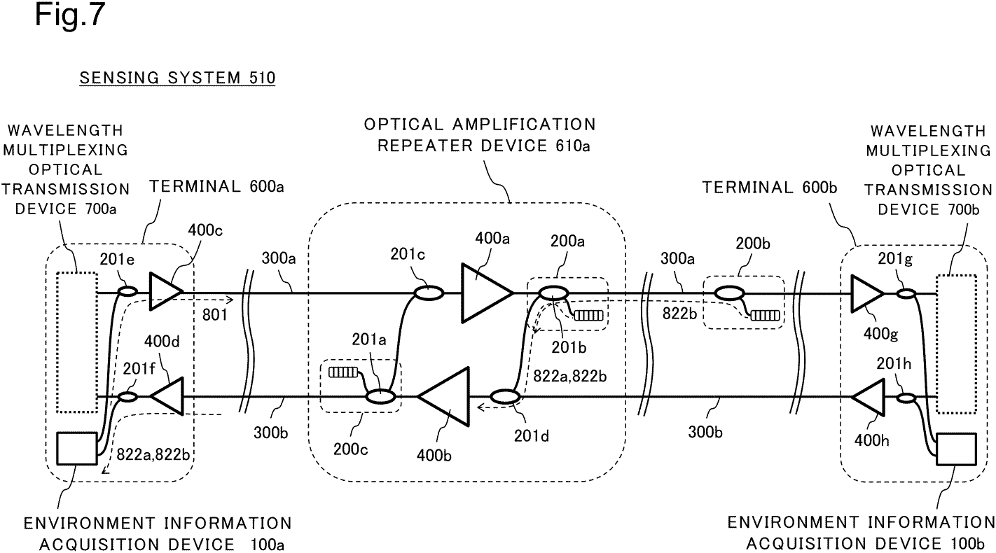

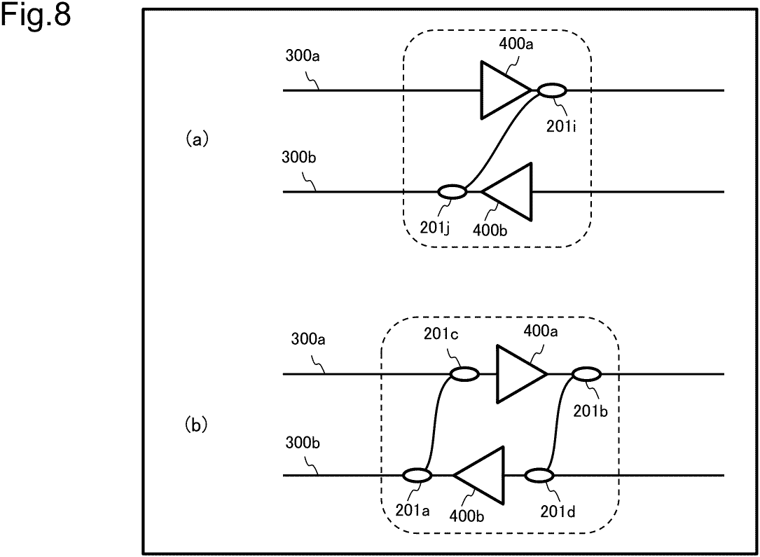

In an optical fiber transmission system, an optical amplification repeater device is widely used, but an optical amplifier included in the optical amplification repeater device is generally designed for passage only in one direction. Therefore, in a common optical fiber transmission system, by using two optical fiber core wires, bi-directional communication is achieved. Therefore, in the sensing system 510 of FIG. 6, in order for probe light and reflection return light to be transmitted bidirectionally through one optical fiber core wire, a path for transferring reflection return light to an opposite optical fiber core wire is required before and after each optical amplification repeater, as illustrated in one example of FIG. 7. In a repeater configuration oppositely including two optical amplifiers with unidirectionality in this manner, a path for transferring reflection return light to an opposite optical fiber core wire is well-known as explained, for example, in PTL 3. In particular, two configurations illustrated in FIG. 8 are widely used. FIG. 7 is an example using a configuration in FIG. 8(b).

FIG. 7 is a conceptual diagram illustrating internal connection in the sensing system 510 of FIG. 6. The sensing system 510 includes terminals 600a and 600b, optical fibers 300a and 300b, one or more optical amplification repeater devices 610 in FIG. 6, and one or more partial reflectors 200 in FIG. 6. In FIG. 7, among these components, an optical amplification repeater device 610a being one optical amplification repeater device 610 in FIG. 6 and a partial reflector 200b being one partial reflector 200 in FIG. 6 are illustrated as an example, and illustration of others is omitted. While not illustrated in FIG. 7, the optical fibers 300a and 300b are accommodated in the same cable.

The terminal 600a includes a wavelength multiplexing optical transmission device 700a, an environment information acquisition device 100a, optical couplers 201e and 201f, and optical amplifiers 400c and 400d. The terminal 600b includes a wavelength multiplexing optical transmission device 700b, an environment information acquisition device 100b, optical couplers 201g and 201h, and optical amplifiers 400g and 400h. The optical amplification repeater device 610a includes optical amplifiers 400a and 400b, partial reflectors 200a and 200c, and optical couplers 201c and 201d.

The wavelength multiplexing optical transmission device 700a performs, via the optical fibers 300a and 300b, bi-directional optical communication with the wavelength multiplexing optical transmission device 700b. The optical fiber 300a is used for transmitting an optical signal from the wavelength multiplexing optical transmission device 700a to the wavelength multiplexing optical transmission device 700b. The optical signal is repeater-amplified by the optical amplifiers 400c, 400a, and 400g. The optical fiber 300b is used for transmitting an optical signal from the wavelength multiplexing optical transmission device 700b to the wavelength multiplexing optical transmission device 700a. The optical signal is repeater-amplified by the optical amplifiers 400h, 400b, and 400d.

Each of the environment information acquisition devices 100a and 100b includes a configuration similar to the environment information acquisition device 100 in FIG. 2.

Probe light 801 transmitted, via the optical coupler 201e, from the environment information acquisition device 100a to the optical fiber 300a travels rightward through the optical fiber 300a. The probe light 801 is transmitted while being subjected to optical amplification repeat by the optical amplifiers 400c and 400a and thereafter, is caused to enter the partial reflector 200a.

Reflection light 822a of the probe light 801 reflected by the partial reflector 200a enters the optical fiber 300b via the optical couplers 201b and 201d. The reflection light 822a is transmitted while being subjected to optical amplification repeat by the optical amplifiers 400b and 400d and thereafter, is branched by the optical coupler 201f and enters the environment information acquisition device 100a. The environment information acquisition device 100a acquires, from the reflection light 822a, environment information of the partial reflector 200a.

The above-described probe light 801 having partially passed through the partial reflector 200a enters the partial reflector 200b on a right side of the partial reflector 200a. Reflection light 822b of the probe light 801 reflected by the partial reflector 200b passes through the optical fiber 300a and enters the optical fiber 300b via the optical couplers 201b and 201d. Hereafter, the reflection light 822b enters the environment information acquisition device 100a, similarly to the reflection light 822a. The environment information acquisition device 100a acquires, from the reflection light 822b, environment information of the partial reflector 200b.

Similarly, probe light transmitted from the environment information acquisition device 100b to the optical fiber 300b travels leftward through the optical fiber 300b and is reflected by the partial reflector 200c and returns to the environment information acquisition device 100b, and then environment information of the partial reflector 200c is acquired. Environment information is acquired on both of the optical fiber 300a side and the optical fiber 300b side, and thereby redundancy can be achieved, and in addition, distant environment information having difficulty in being measured even via optical amplification repeat can be acquired.

When environment information is acquired based on the present technique from both directions in this manner, a wavelength of probe light transmitted on the optical fiber 300a side and a wavelength of probe light transmitted on the optical fiber 300b side are preferably different from each other. The reason is that when the wavelengths are the same, light returned by reflection between partial reflectors is partially reflected again by a partial reflector.

FIG. 7 illustrates an example in which the partial reflectors 200a and 200c are disposed inside the optical amplification repeater device 610a and the partial reflector 200b is disposed in a middle of an optical fiber cable. As illustrated in FIG. 6, the partial reflector 200 can be disposed in a location different from the optical amplification repeater device 610. The optical amplification repeater device 610 is inserted in order to compensate a loss of an optical fiber, and therefore, of course, there may be a difference from a location intended to install the partial reflector 200. As described later, both of an embodiment in which the partial reflector 200 is installed inside the optical amplification repeater device 610 and an embodiment in which the partial reflector 200 is installed in a location distant from the optical amplification repeater device 610 have characteristics. Therefore, these embodiments are selectable according to a purpose of sensing or the like.

### Classification of Disposition Locations of FBG Sensor and Each Characteristic

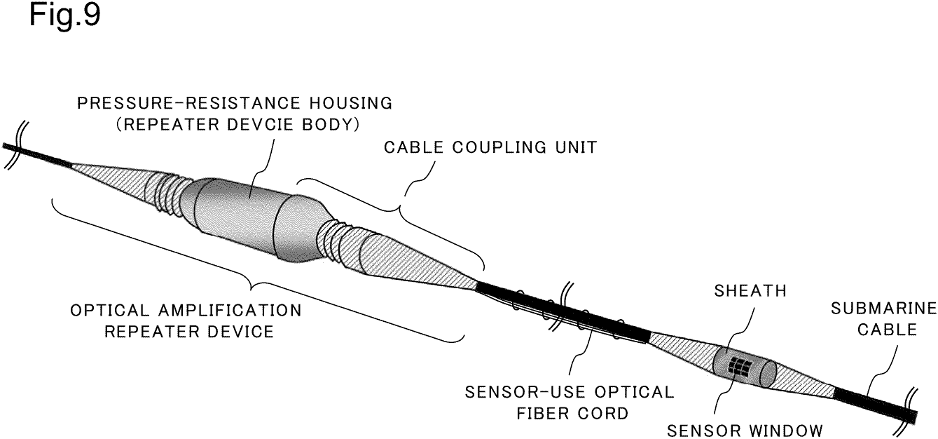

As described above, the partial reflector 200 can be included in a housing of the optical amplification repeater device 610 or can be disposed outside the housing of the optical amplification repeater device 610. FIG. 9 is a diagram schematically explaining an example in which a housing (sheath) for accommodating an FBG sensor configuring the partial reflector 200 is present outside the housing of the optical amplification repeater device 610.

Without limitation to the FBG sensor, according to a type of environment information to be acquired by a sensor, in order to acquire environment information, it is necessary to expose the sensor to a surrounding environment of the sensor. In contrast, generally, an inside of a cable or a repeater is applied with very high voltage between the inside and external seawater in order to supply power for driving the repeater or the like and therefore, is applied with high-degree insulation. Therefore, it is very difficult to expose a sensor including an electronic circuit to a surrounding environment. In contrast, an optical fiber sensor including an FBG does not require electric wiring, and therefore it has a feature of easily achieving electric insulation when a sensor is installed by being exposed to a surrounding environment. It can be said that this matter is particularly an important feature in a submarine cable system requiring insulation against high voltage.

However, a submarine cable is subjected to an impact or abrasion during movement or laying, and therefore it is necessary to mechanically protect a sensor unit. Therefore, while a sensor unit is covered with a protection cover (sheath) for mechanically protecting the sensor unit, a window for exposure to an environment is provided for the protection cover (sheath), and thereby it is desirable for external environment information to easily propagate to the sensor.

### Configuration in Which FBG Sensor is Installed Outside Repeater Device and Characteristics Thereof

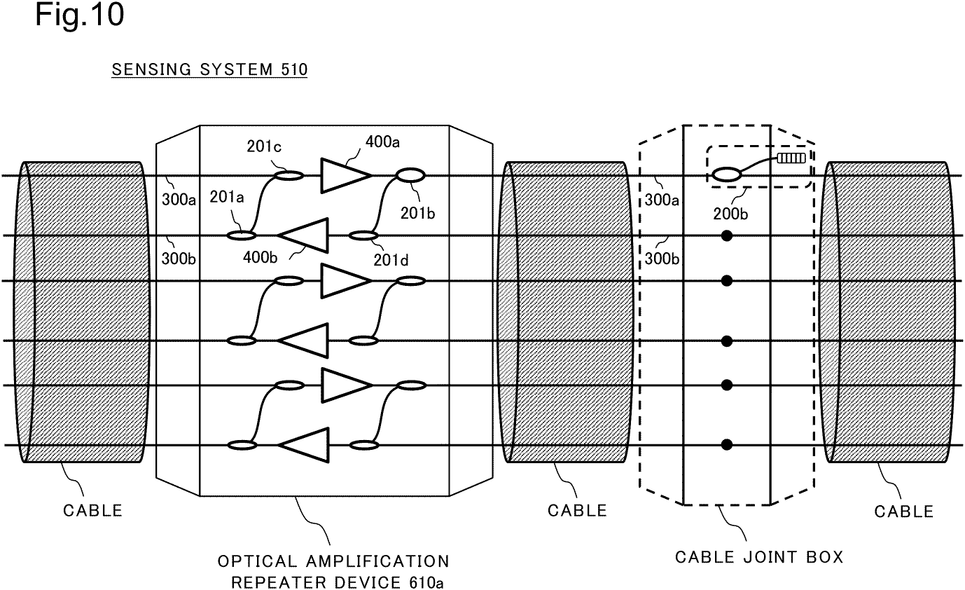

It is conceivable that a method of disposing an FBG sensor outside a housing of an optical amplification repeater device and in a middle of an optical cable is roughly divided into two embodiments. A first embodiment is an embodiment including a configuration in which as illustrated as one example in FIG. 10, once, an optical cable is cut, an optical fiber connected to an FBG sensor is taken out from a structure of the optical cable, and thereafter the optical fiber is connected again. In order to achieve the embodiment, it is effective to use a configuration of a cable joint box for connecting optical cables. In a connection point between cables, it is necessary to ensure, at a level equal to or higher than the cable, characteristics, such as allowable tension and high-voltage insulation, required for the cable, and therefore an advanced technique is required.

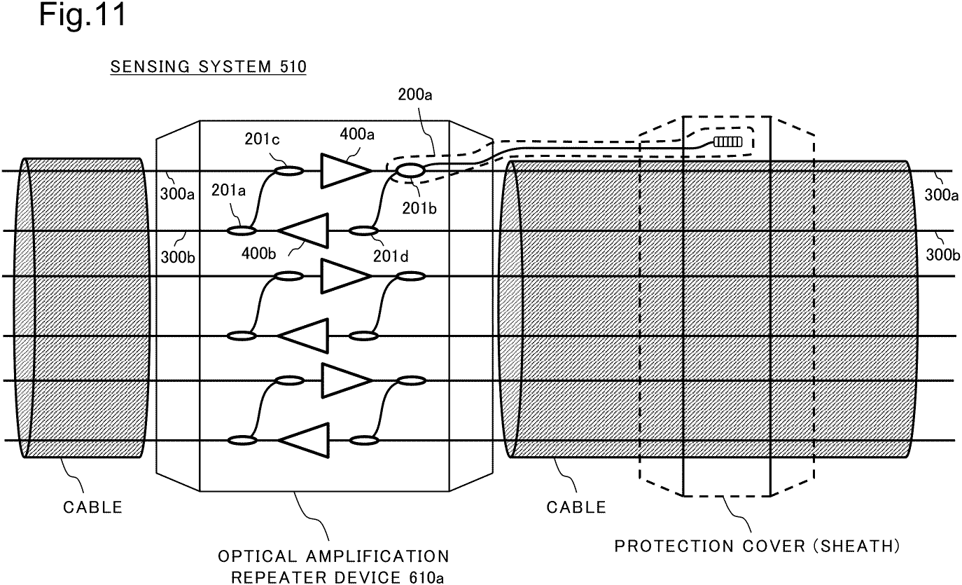

A second embodiment is an embodiment including a configuration of connecting between a repeater device and a sheath by an optical fiber cord being a separate line from an optical cable as a main line, as one example in FIG. 11. The optical fiber cord as the separate line includes an optical fiber connected to an FBG sensor. Other components configuring a partial reflector are placed in the repeater device. In the example of FIG. 11, only an FBG sensor of the partial reflector 200a in FIG. 7 is installed in a distant location. FIG. 9 illustrates an example of an appearance of the second embodiment. The second embodiment is limited to a range where a distance from the repeater device to the FBG sensor is relatively short, but it is unnecessary to cut the optical cable of the main line in a sheath location and connect the cut optical cable, and therefore a risk of impairing reliability is reduced. In addition, the second embodiment is simpler than the first embodiment in which the configuration of the cable joint box is used, and therefore cost reduction may be achieved.

FIGS. 10 and 11 also illustrate two sets of other optical fiber core wire pairs (optical fiber pairs) accommodated in the same cable while illustration of these pairs is omitted in FIG. 7. The optical fiber pair additionally illustrated is indicated as being dedicated to communication application. It is customary that one optical fiber cable includes many optical fiber core wires in this manner. Therefore, a cable joint box method in which a cable is cut once and thereafter connected again is likely to be complicated and expensive, compared with a method for installation without cutting a cable.

### Configuration in Which FBG Sensor is Installed in Repeater Device and Characteristics Thereof

It is conceivable that an installation location where an FBG sensor is disposed in a housing of a repeater device incudes two types including a pressure-resistance housing inside and a pressure-resistance housing outside. Environment information surrounding a housing is unlikely to propagate to the pressure-resistance housing inside, and according to heat generation of a repeater amplification device and the like, temperatures inside the housing and outside the housing are different from each other. However, the pressure-resistance housing inside is characteristic of being strictly protected. An acceleration (a direction of a vibration or gravity), an acoustic wave propagating in a pressure-resistance housing, and the like can be sensed by an FBG even inside a housing.

The FBG sensor can be installed inside a cable coupling unit that is a portion for connecting a pressure resistance housing being a body of a repeater device to an optical cable. The cable coupling unit is located in the housing of the repeater device but located outside a pressure wall, and therefore the location is a location to which a water pressure from the outside propagates.

### Comparison With Another Existing Method and Characteristics Thereof

In a submarine optical amplification repeater transmission system, as disclosed, for example, in PTL 3, in order to monitor intensity of optical output of a repeat-use optical amplifier, a configuration in which a partial reflector is inserted into an output side of an optical amplification device may be used. Since an FBG for the configuration is not used for external environment sensing, the FBG is not formed in such a way that a grating pitch easily changes and is merely an optical reflector of a wavelength selectable type. Intensity of reflection light from the FBG can be measured based on OTDR explained in the section of Background Art.

In general, when a sensor is installed in a distant location via an optical fiber transmission path, in order to transmit measurement data to a master station, it is necessary to mount an optical transceiver in a housing. In contrast, remote sensing using an FBG has a feature in that it is unnecessary to mount an electronic circuit or an optical transceiver. When a repeater for communication transmission is shared with a sensing function for external environment information, it is necessary to avoid occurrence of impairment in transmission function, which is caused by a failure or malfunction of a portion functioning as a sensor. A sensing system using an FBG has a feature in that it is unnecessary to mount an electronic circuit or an optical transceiver on a sensor unit, and therefore a failure and malfunction are unlikely to occur and a possibility of decreasing reliability of an optical amplification repeater function is reduced.

The present example embodiment has the feature and in addition, detects a grating pitch change of an FBG due to a change of environment information, by using the environment information acquisition device 100 being a DAS interrogator and thereby, enables measurement with high sensitivity.

### [Advantageous Effect]

According to the sensing system of the present example embodiment, an optical amplification repeater device is inserted into an optical cable, and thereby limitation, due to a loss of an optical fiber, to a range capable of being sensed can be resolved.

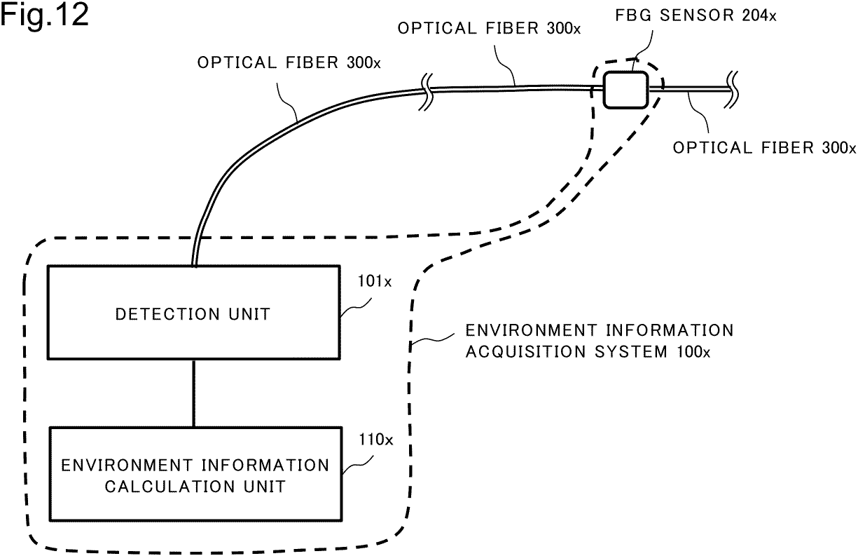

FIG. 12 is a conceptual diagram illustrating a configuration of an environment information acquisition system 100x being a minimum configuration of the environment information acquisition system according to the example embodiments. The environment information acquisition system 100x includes an FBG sensor 204x, a detection unit 101x, and an environment information calculation unit 110x. The FBG sensor 204x is a sensor including a fiber Bragg grating (FBG) in which a grating pitch changes according to peripheral environment information, the FBG sensor being installed on an optical path including an optical fiber 300x. The detection unit 101x detects a phase change of reflection return light from the FBG sensor 204x with respect to probe light transmitted via the optical fiber. The environment information calculation unit 110x calculates, based on the phase change, environment information in a periphery of the FBG sensor 204x.

The environment information acquisition system 100x uses the FBG sensor 204x as a sensor for acquiring environment information and acquires, based on a phase change of reflection return light from the FBG 204x, a degree of a grating pitch change of the FBG. Therefore, first, the environment information acquisition system 100x can increase a reflection light amount from a sensor for acquiring environment information, compared with an optical fiber used for common fiber sensing. In addition, the environment information acquisition system 100x can further acquire environment information with higher sensitivity, compared with a method of acquiring, based on intensity change of reflection return light from an FBG, a degree of a grating pitch change. Therefore, the environment information acquisition system 100x easily acquires environment information in a distant observation point. Therefore, the environment information acquisition system 100x exhibits, based on the configuration, the advantageous effect described in the section of [Advantageous Effects of Invention].

As described above, while the example embodiments according to the present invention have been described, the present invention is not limited to the example embodiments, and further changes, substitutions, and adjustments may be added without departing from the fundamental technical spirit of the present invention. For example, a configuration of elements illustrated in each of drawings is one example for assisting understanding of the present invention, without limitation to the configurations illustrated in these drawings.

The whole or part of the example embodiments described above can be described as, but not limited to, the following supplementary notes.

### Supplementary Note 1

An environment information acquisition system including:
a fiber Bragg grating (FBG) sensor being a sensor including an FBG in which a grating pitch changes according to peripheral environment information, the FBG sensor being installed on an optical path including an optical fiber;
a detection unit that detects a phase change of reflection return light from the FBG sensor with respect to probe light transmitted via the optical fiber; and
an environment information calculation unit that calculates, based on the phase change, environment information in a periphery of the FBG sensor.

### Supplementary Note 2

The environment information acquisition system according to supplementary note 1, wherein

the FBG sensor is included in a partial reflector in which a part of the probe light is reflected to the detection unit by the FBG sensor and through which another part of the probe light passes.

### Supplementary Note 3

The environment information acquisition system according to claim 2, wherein a plurality of the partial reflectors are included, and a reflectance with respect to reflection of the probe light in the partial reflector is larger as intensity of the probe light reaching the partial reflector is smaller.

### Supplementary Note 4

The environment information acquisition system according to any one of supplementary notes 2 and 3, wherein

the optical fiber includes a first optical fiber and a second optical fiber, and further includes an optical path that causes a part of reflection light being the reflected light, to the first optical fiber, of the probe light transmitted through the first optical fiber, to enter the second optical fiber in a direction of the detection unit.

### Supplementary Note 5

The environment information acquisition system according to supplementary note 4, wherein, between a transmission unit being a portion for transmitting the probe light of the first optical fiber and the optical path, a first optical amplifier that optically amplifies an optical signal travelling from the transmission unit to the optical path is inserted, and between the detection unit of the second optical fiber and the optical path, a second optical amplifier that optically amplifies an optical signal travelling from the optical path to the detection unit is inserted.

### Supplementary Note 6

The environment information acquisition system according to supplementary note 5, wherein the first optical amplifier optically amplifies an optical signal to be transmitted to a second optical communication device via the first optical fiber by a first optical communication device installed on a same side as the transmission unit in a location relation with the first optical fiber.

### Supplementary Note 7

The environment information acquisition system according to supplementary note 5 or 6, wherein the FBG sensor is installed separately from a housing including the first optical amplifier and the second optical amplifier.

### Supplementary Note 8

The environment information acquisition system according to supplementary note 7, wherein the FBG sensor is mounted on a cable joint box being a portion that connects an optical cable including the optical fiber.

### Supplementary Note 9

The environment information acquisition system according to supplementary note 7, wherein the FBG sensor is connected, by using another optical fiber different from the optical fiber, to a housing including the first optical amplifier and the second optical amplifier.

### Supplementary Note 10

The environment information acquisition system according to any one of supplementary notes 1 to 9, wherein the FBG sensor is accommodated in a structure formed in such a way that sensitivity to a physical phenomenon representing the environment information as a detection target is higher than sensitivity to a physical phenomenon other than the former physical phenomenon.

### Supplementary Note 11

The environment information acquisition system according to any one of supplementary notes 1 to 10, wherein the detection unit is included in a distributed acoustic sensing interrogator.

### Supplementary Note 12

An environment information acquisition method including:
detecting, with respect to probe light transmitted via an optical fiber, a phase change of reflection return light from a fiber Bragg grating (FBG) sensor being a sensor including an FBG in which a grating pitch changes according to peripheral environment information, the FBG sensor being installed on an optical path including the optical fiber; and
calculating, based on the phase change, environment information in a periphery of the FBG sensor.

### Supplementary Note 13

An environment information acquisition program causing a computer to execute:
processing of detecting, with respect to probe light transmitted via an optical fiber, a phase change of reflection return light from a fiber Bragg grating (FBG) sensor being a sensor including an FBG in which a grating pitch changes according to peripheral environment information, the FBG sensor being installed on an optical path including the optical fiber; and
processing of calculating, based on the phase change, environment information in a periphery of the FBG sensor.

### Supplementary Note 14

The environment information acquisition system according to supplementary note 2, wherein the partial reflector includes: an optical coupler that takes out a part of the probe light from the optical fiber; an optical path that causes the part of the probe light taken out by the optical coupler, to enter the FBG sensor; and the FBG sensor, and the optical path and the optical coupler input, to the optical fiber, reflection light being the reflected light.

### Supplementary Note 15

The environment information acquisition system according to supplementary note 1, wherein the environment information includes temperature, pressure, or vibration.

Herein, “the optical fiber” according to the supplementary notes is, for example, the optical fiber 300 in FIGS. 1 to 3 or FIG. 6 or a combination of the optical fiber 300a and the optical fiber 300b in FIG. 7. “The probe light” is, for example, probe light emitted from the modulation unit 104 in FIG. 2.

“The FBG sensor” is, for example, the FBG 204 in FIG. 3 or the FBG sensor 204x in FIG. 12. “The detection unit” is, for example, a combination of the detection unit 102 and the acquisition processing unit 101 in FIG. 2 or the detection unit 101x in FIG. 12. “The environment information calculation unit” is, for example, the environment information acquisition unit 110 in FIG. 2 or the environment information calculation unit 110x in FIG. 12. “The environment information acquisition system” is, for example, the sensing system 500 in FIG. 1, the sensing system 510 in FIG. 6 or FIG. 7, or the environment information acquisition system 100x in FIG. 12.

“The partial reflector” is, for example, the partial reflector 200 in FIGS. 1, 3, and 6 or the partial reflector 200a, 200b, or 200c in FIG. 7. “The first optical fiber” is, for example, one of the optical fibers 300a and 300b in FIG. 7. “The second optical fiber” is, for example, an optical fiber being not the first optical fiber of the optical fibers 300a and 300b in FIG. 7. “The transmission unit” is, for example, the modulation unit 104 in FIG. 2.

“The optical path” is, for example, an optical path between the optical coupler 201a and the optical coupler 201c or an optical path between the optical coupler 201b and the optical coupler 201d in FIG. 7, or an optical path between an optical coupler 201i and an optical coupler 201j in FIG. 8(a). “The first optical amplifier” is, for example, one of the optical amplifiers 400a and 400b in FIG. 7. “The second optical amplifier” is, for example, an optical amplifier being not a first optical amplifier of the optical amplifiers 400a and 400b in FIG. 7.

A matter that “the FBG sensor is installed separately from a housing including the first optical amplifier and the second optical amplifier” indicates, for example, the configuration in FIG. 9, FIG. 10, or FIG. 11. A matter that “the FBG sensor is connected, by using another optical fiber different from the optical fiber, to a housing including the first optical amplifier and the second optical amplifier” is, for example, the configuration in FIG. 9 or FIG. 11.

“The distributed acoustic sensing interrogator” is, for example, an interrogator including the environment information acquisition device 100 in FIG. 2. “The computer” is, for example, a computer included in the environment information acquisition device 100 in FIG. 2. “The environment information acquisition program” is, for example, a program for causing a computer to execute processing and is stored in a storage unit included in the environment information acquisition device 100.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-143155 filed on Aug. 27, 2020, the disclosure of which is incorporated herein in its entirety by reference.

Reference signs List

| | |
|---|---|
| 100 | Environment information acquisition device |
| 200 | Partial reflector |
| 201 | Optical coupler |
| 202 | Non-reflection terminal |
| 203 | Optical attenuation element |
| 204 | FBG sensor |
| 300 | Optical fiber |
| 400 | Optical amplifier |
| 500, 510 | Sensing system |
| 600 | Terminal |
| 610 | Optical amplification repeater device |
| 700 | Wavelength multiplexing optical transmission device |
| 801 | Probe light |
| 822, 822a, 822b | Reflection light |

What is claimed is:

1. An environment information acquisition system comprising:
a fiber Bragg grating (FBG) sensor being a sensor including an FBG in which a grating pitch changes according to peripheral environment information, the FBG sensor being installed on an optical path including an optical fiber;
a detector configured to detect a phase change of reflection return light from the FBG sensor with respect to probe light transmitted via the optical fiber; and
an environment information calculator configured to calculate, based on the phase change, environment information in a periphery of the FBG sensor.

2. The environment information acquisition system according to claim 1, wherein
the FBG sensor is included in a partial reflector in which a part of the probe light is reflected to the detector by the FBG sensor and through which another part of the probe light passes.

3. The environment information acquisition system according to claim 2, wherein a plurality of the partial reflectors are included, and a reflectance with respect to reflection of the probe light in the partial reflector is larger as intensity of the probe light reaching the partial reflector is smaller.

4. The environment information acquisition system according to claim 2, wherein
the optical fiber includes a first optical fiber and a second optical fiber, and further includes an optical path that causes a part of reflection light being the reflected light, to the first optical fiber, of the probe light transmitted through the first optical fiber, to enter the second optical fiber in a direction of the detector.

5. The environment information acquisition system according to claim 4, wherein, between a transmission portion being a portion for transmitting the probe light of the first optical fiber and the optical path, a first optical amplifier that optically amplifies an optical signal travelling from the transmission portion to the optical path is inserted, and between the detector of the second optical fiber and the optical path, a second optical amplifier that optically amplifies an optical signal travelling from the optical path to the detector is inserted.

6. The environment information acquisition system according to claim 5, wherein the first optical amplifier optically amplifies an optical signal to be transmitted to a second optical communication device via the first optical fiber by a first optical communication device installed on a same side as the transmission portion in a location relation with the first optical fiber.

7. The environment information acquisition system according to claim 5, wherein the FBG sensor is installed separately from a housing including the first optical amplifier and the second optical amplifier.

8. The environment information acquisition system according to claim 7, wherein the FBG sensor is mounted on a cable joint box being a portion that connects an optical cable including the optical fiber.

9. The environment information acquisition system according to claim 7, wherein the FBG sensor is connected, by using another optical fiber different from the optical fiber, to a housing including the first optical amplifier and the second optical amplifier.

10. The environment information acquisition system according to claim 1, wherein the FBG sensor is accommodated in a structure formed in such a way that sensitivity to a physical phenomenon representing the environment information as a detection target is higher than sensitivity to a physical phenomenon other than the former physical phenomenon.

11. The environment information acquisition system according to claim 1, wherein the detector is included in a distributed acoustic sensing interrogator.

12. An environment information acquisition method comprising:
detecting, with respect to probe light transmitted via an optical fiber, a phase change of reflection return light from a fiber Bragg grating (FBG) sensor being a sensor including an FBG in which a grating pitch changes according to peripheral environment information, the FBG sensor being installed on an optical path including the optical fiber; and
calculating, based on the phase change, environment information in a periphery of the FBG sensor.

13. A recording medium recording an environment information acquisition program causing a computer to execute:
processing of detecting, with respect to probe light transmitted via an optical fiber, a phase change of reflection return light from a fiber Bragg grating (FBG) sensor being a sensor including an FBG in which a grating pitch changes according to peripheral environment information, the FBG sensor being installed on an optical path including the optical fiber; and
processing of calculating, based on the phase change, environment information in a periphery of the FBG sensor.

14. The environment information acquisition system according to claim 2, wherein the partial reflector includes an optical coupler that takes out a part of the probe light from the optical fiber, an optical path that causes the part of the probe light taken out by the optical coupler, to enter the FBG sensor, and the FBG sensor, and
the optical path and the optical coupler input, to the optical fiber, reflection light being the reflected light.

15. The environment information acquisition system according to claim 1, wherein the environment information includes temperature, pressure, or vibration.

16. The environment information acquisition system according to claim 3, wherein
the optical fiber includes a first optical fiber and a second optical fiber, and further includes an optical path that causes a part of reflection light being the reflected light, to the first optical fiber, of the probe light transmitted through the first optical fiber, to enter the second optical fiber in a direction of the detector.

17. The environment information acquisition system according to claim 6, wherein the FBG sensor is installed separately from a housing including the first optical amplifier and the second optical amplifier.

18. The environment information acquisition system according to claim 2, wherein the FBG sensor is accommodated in a structure formed in such a way that sensitivity to a physical phenomenon representing the environment information as a detection target is higher than sensitivity to a physical phenomenon other than the former physical phenomenon.

19. The environment information acquisition system according to claim 3, wherein the FBG sensor is accommodated in a structure formed in such a way that sensitivity to a physical phenomenon representing the environment information as a detection target is higher than sensitivity to a physical phenomenon other than the former physical phenomenon.

20. The environment information acquisition system according to claim 4, wherein the FBG sensor is accommodated in a structure formed in such a way that sensitivity to a physical phenomenon representing the environment information as a detection target is higher than sensitivity to a physical phenomenon other than the former physical phenomenon.
